(19) United States
(12) Patent Application Publication
(10) Pub. No.: US 2026/0298890 A1
(43) Pub. Date: Oct. 1, 2026

(54) Methods and Systems for Identifying Bioactive Compounds in Herbal Medicines Through Patient Response Analysis

(71) Applicant: Jianyi Zhang, Clarksville, MD (US)

(72) Inventor: Jianyi Zhang, Clarksville, MD (US)

(21) Appl. No.: 19/531,289

(22) Filed: Feb. 5, 2026

(51) Int. Cl. G01N 30/72; G01N 30/02; G01N 30/86; G01N 30/88

(52) U.S. Cl. CPC G01N 30/7233; G01N 30/861; G01N 2030/027; G01N 2030/8822

(57) ABSTRACT

Methods and systems are provided for identifying bioactive compounds in herbal medicines through analysis of patient responses. The method includes establishing objective, measurable clinical criteria for treatment effectiveness; treating patients with the selected herbal medicine; classifying patients as responders or non-responders based on the criteria; analyzing blood samples from both groups using liquid chromatography-mass spectrometry (LC-MS); identifying common elements (CEs) consistently present in responders; determining which non-responders lack one or more CEs; estimating required concentrations of missing CEs using pharmacokinetic principles; administering the missing or supplemental CEs to those non-responders; and confirming bioactivity if clinical improvement occurs. This approach links specific compounds to therapeutic efficacy, overcomes limitations of traditional isolation and screening, and reduces time and cost. The method applies to Traditional Chinese Medicine, Ayurvedic medicine, and other herbal systems with definable efficacy criteria and responsive patient populations.

### CROSS REFERENCE TO RELATED APPLICATIONS

This application claims priority to U.S. Provisional Patent Application No. 63/368,947, filed on Jul. 18, 2022. The entire contents of the prior application are hereby incorporated by reference.

### FIELD OF THE INVENTION

This invention relates to methods and systems for identifying bioactive compounds in herbal medicines. More specifically, the invention relates to a patient response-based methodology for discovering and validating bioactive compounds present in herbal formulations through analysis of blood samples from clinically responsive patients.

### BACKGROUND OF THE INVENTION

### 1.1 Traditional Approaches to Compound Identification in Herbal Medicines

Traditional Chinese Medicine (TCM) has been practiced for thousands of years and has made significant contributions to human health and longevity. However, the scientific understanding of the active compounds responsible for TCM's therapeutic effects remains incomplete (Xue & Roy, 2003).

1.2 Analytical Chemistry Methods and their Limitations

Several analytical chemistry methods have been developed to identify and characterize chemical compounds in herbal preparations. These methods include high performance liquid chromatography (HPLC) and liquid chromatography tandem mass spectrometry (LC-MS) (Sommer et al., 2006; Keevil, 2013). These analytical techniques are powerful tools that can identify numerous chemical compounds in herbal extracts and can measure their concentrations with high precision and sensitivity.

However, these analytical methods have a fundamental limitation: they can identify chemical peaks corresponding to different compounds, but they cannot associate these peaks with therapeutic efficacy or safety. In other words, analytical chemistry can tell you what compounds are present in herbal medicine, but it cannot tell you which of these compounds are responsible for the medicine's therapeutic effects or whether these compounds are safe for human use (Wang et al., 2023).

This limitation creates a significant bottleneck in TCM research. Even when researchers successfully identify all the chemical compounds present in an herbal medicine, they still face the daunting task of determining which compounds (or combinations of compounds) are responsible for the observed therapeutic effects. Testing each compound individually is prohibitively expensive and time-consuming, and it cannot capture synergistic effects among multiple compounds (Morgan et al., 2011).

1.3 the Problem this Invention Addresses

The pharmaceutical industry faces a critical challenge in drug development. Bringing a new drug from initial discovery to FDA approval typically requires 10-15 years of research and development and costs approximately $2-3 billion (Morgan et al., 2011; Tang et al., 2014). The vast majority of this time and expense is devoted to testing candidate compounds to determine whether they are safe and effective. Most candidate compounds fail during testing, meaning that the resources invested in their development are essentially wasted.

This high cost and long timeline create a significant barrier to drug development, particularly for treatments targeting rare diseases or conditions affecting populations with limited economic resources. The pharmaceutical industry needs more efficient methodologies that can accelerate the identification of promising bioactive compounds and reduce the resources required for development.

The present invention addresses this problem by providing a novel methodology for identifying bioactive compounds in herbal medicines based on patient clinical responses rather than relying exclusively on chemical isolation and screening methods. By analyzing blood samples from patients who respond clinically to herbal treatment and comparing them to blood samples from patients who do not respond, the present invention can identify specific chemical compounds that are associated with clinical efficacy. These compounds can then be validated through controlled administration to non-responding patients, providing evidence that these compounds are genuinely bioactive.

### BRIEF DESCRIPTION OF THE DRAWINGS

FIG. 1 illustrates the general process for identifying potential bioactive compounds (Common Elements) through patient response analysis. The figure shows the sequential steps of establishing efficacy criteria, treating patients, classifying responders and non-responders, analyzing blood samples, identifying Common Elements, and validating bioactive compounds.

FIG. 2 illustrates the application of the methodology to the treatment of bacterial infections using clove (Syzygium aromaticum) preparations. The figure demonstrates the identification of three Common Elements in patients responding to clove treatment and the subsequent validation of these compounds through administration to non-responding patients.

FIG. 3 illustrates the application of the methodology to the treatment of hypertension using Cinnamomum verum (Ceylon cinnamon) preparations. The figure demonstrates a dose-response relationship, where patients with lower concentrations of one Common Element respond to treatment when given increased doses of this element.

### DETAILED DESCRIPTION OF THE INVENTION

### 1. Introduction and Theoretical Basis

The present invention is based on the recognition that patients who respond clinically to herbal treatment possess a specific set of bioactive compounds in their blood that are absent or present in reduced concentrations in patients who do not respond. By identifying the compounds present in all responders and absent in non-responders, the invention enables direct identification of bioactive compounds without the need for extensive individual compound testing.

The theoretical basis for this approach rests on several key principles. First, for a compound to produce a therapeutic effect, it must be present in the patient's body at a sufficient concentration. Second, the compound must reach the relevant target tissues and organs where it can exert its biological effects. Third, the patient's body must possess the necessary biochemical machinery (enzymes, receptors, signaling pathways) to process the compound and generate the desired therapeutic response. This last principle is referred to in the present application as the “complete reaction chain”.

The complete reaction chain encompasses all the biochemical processes necessary for a therapeutic effect to occur. Even if a patient possesses all the necessary bioactive compounds at appropriate concentrations, if the patient lacks any critical component of the complete reaction chain, the therapeutic effect will not occur. For example, a patient might lack a specific enzyme required to metabolize a bioactive compound or might lack a cellular receptor necessary for the compound to exert its biological effects. In such cases, the patient will not respond to treatment even though all necessary bioactive compounds are present.

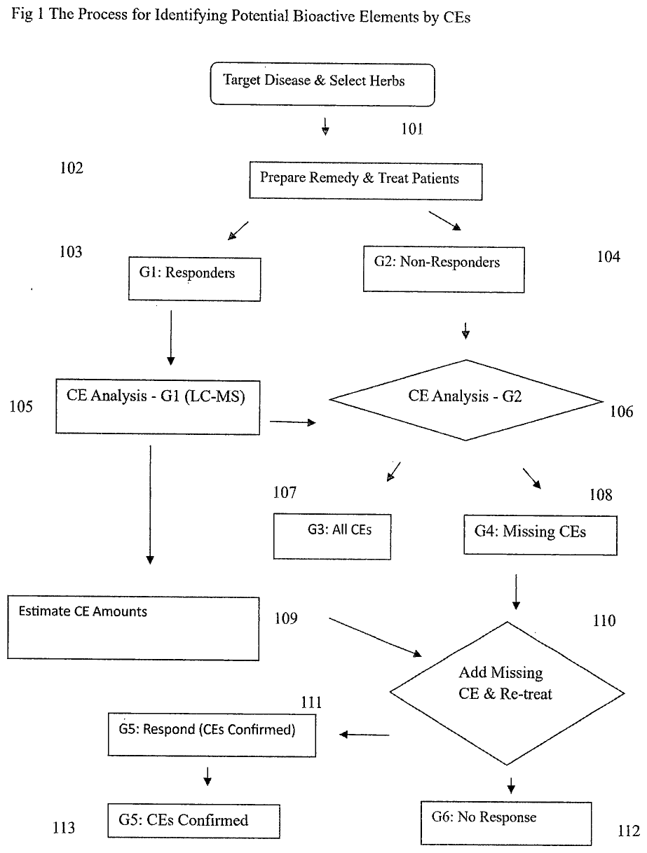

### 2. General Description of the Methodology (FIG. 1)

The methodology of the present invention proceeds through the following sequential steps:

### Step 1: Establish Objective Clinical Criteria for Treatment Effectiveness

The first step in applying the methodology is to establish clear, objective, measurable criteria for assessing whether a patient has responded to treatment. These criteria must be specific to the medical condition being treated and must be capable of being assessed reliably and reproducibly. For example, in treating bacterial infections, objective criteria might include body temperature returning to normal range (36.5-37.5° C.), white blood cell count returning to normal range (4,500-11,000 cells/μL), and negative bacterial culture results. In treating hypertension, objective criteria might include systolic blood pressure reduced to below 140 mmHg and diastolic blood pressure reduced to below 90 mmHg. In treating diabetes, objective criteria might include fasting blood glucose reduced to below 126 mg/dL and hemoglobin A1c reduced to below 6.5%.

The objective criteria must be established before patient treatment begins and must be applied consistently to all patients. This prevents bias in classifying patients as responders or non-responders.

### Step 2: Select and Prepare Herbal Medicine 101

The herbal medicine to be studied is selected based on traditional use for treating the specific medical condition. The herbal material is obtained from a reliable source and is authenticated to confirm its botanical identity. The herbal material is then processed to produce an extract or formulation suitable for patient administration.

The preparation process should be documented in detail, including the plant parts used, extraction solvents, extraction methods (cold or hot), extraction duration, and any subsequent processing steps. This documentation ensures that the preparation can be reproduced reliably in future studies (Ong, 2004). 102

### Step 3: Treat Patient Population and Classify Responders and Non-Responders

A population of patients with the target medical condition is enrolled in the study. The patients are treated with herbal medicine according to a defined protocol, including dosage, frequency, and duration of administration. After a pre-determined assessment period, each patient is evaluated against the objective criteria established in Step 1. Patients meeting the pre-established criteria for improvement are classified as responders (designated as Group 1 or G1). Patients not meeting these criteria are classified as non-responders (designated as Group 2 or G2). 103 and 104

### Step 4: Obtain and Analyze Blood Samples

Blood samples are obtained from all patients (both responders and non-responders) at a pre-determined time point after herbal medicine administration. The blood samples are processed to obtain plasma or serum, which is then analyzed using liquid chromatography-mass spectrometry (LC-MS) to identify all chemical compounds present (Sommer et al., 2006; Keevil, 2013). 105

The LC-MS analysis produces a chromatogram showing numerous peaks, each corresponding to a different chemical compound. The analysis identifies the mass-to-charge ratio (m/z), retention time, and relative abundance of each peak.

### Step 5: Identify Common Elements (CEs)

The LC-MS data from all responders (G1) is analyzed to identify chemical compounds that are present in all responders (Table 1). These compounds are designated as “Common Elements” or CEs. The presence of a compound in “all responders” is defined as detection of the compound in 100% of the responder population, or alternatively, detection in a pre-specified statistical majority (e.g., 95% or 90%) if the population is large.

The identification of CEs is performed using a systematic analysis of the LC-MS chromatograms. For each peak detected in the responder population, the frequency of detection across all responders is calculated. Peaks detected in all (or nearly all) responders are identified as CEs.

### Step 6: Analyze Non-Responder Blood Samples

The LC-MS data from non-responders (G2) is analyzed to determine which non-responders possess all the identified CEs and which lack one or more CEs (Table 1). 106

Non-responders who possess all identified CEs (designated as Group 3 or G3) are distinguished from non-responders who lack one or more CEs (designated as Group 4 or G4). The presence of all CEs in G3 patients despite their failure to respond to treatment suggests that these patients lack a complete reaction chain—the biochemical machinery necessary for the CEs to produce a therapeutic effect. 107 and 108

### Step 7: Estimate CE Concentrations in Herbal Preparation

For non-responders in G4 who lack one or more CEs, the concentration of the missing CE(s) in the original herbal preparation is estimated using pharmacokinetic principles. Specifically, the apparent volume of distribution (Vd) is used to estimate the dose of the missing compound that would be required to achieve therapeutic blood concentrations.

The apparent volume of distribution is calculated using the formula: Vd=Dose/C₀, where Dose is the amount of compound administered and C₀ is the initial plasma concentration immediately after administration. Rearranging this formula: Dose=Vd×C₀.

The Vd for the missing compound can be estimated by assuming that its pharmacokinetic properties are similar to those of known compounds with similar chemical structures. For example, if the missing compound is structurally similar to compounds C1 and C3 (which are identified CEs), the Vd of the missing compound can be estimated as the average of the Vd values for C1 and C3 (Table 2). 109

### Step 8: Administer Missing or Insufficient CEs to Non-Responders 110

Non-responders in G4 (those lacking complete CEs) are treated with the missing CE(s) or with increased doses of CEs present at lower than optimal concentrations. These compounds can be administered as purified, isolated compounds obtained from commercial sources, or as synthetically produced compounds.

### Step 9: Confirm Bioactivity of CEs

After treatment with the missing or supplemented CEs, patients are re-evaluated against the objective criteria established in Step 1. Patients who now meet the criteria for clinical improvement (G5) are considered to have responded to the CE treatment, confirming that these compounds are bioactive. 111

Patients who do not respond to treatment even after receiving all necessary CEs (designated as Group 6 or G6) are presumed to lack a complete reaction chain and therefore cannot respond to the herbal treatment regardless of the bioactive compounds present. 112

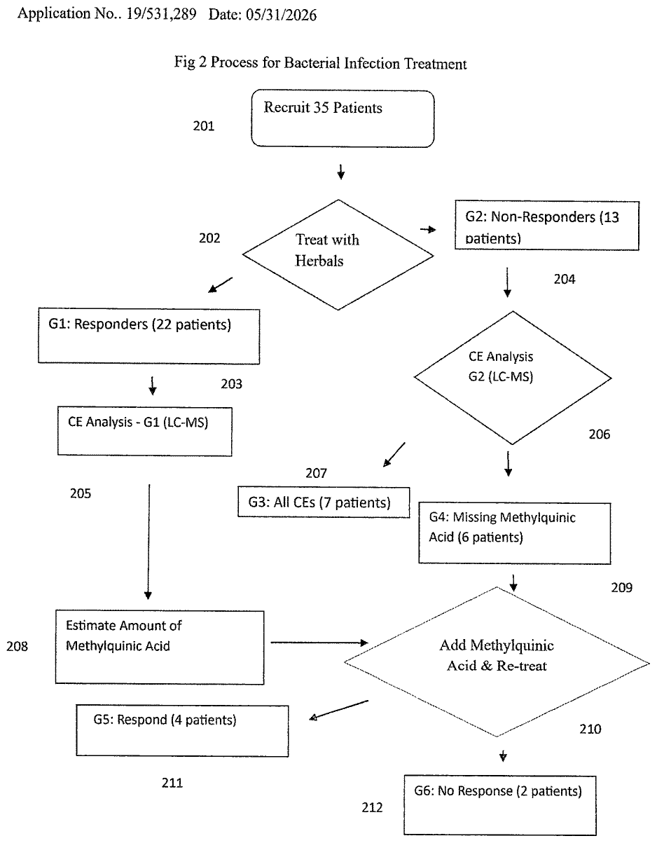

### 3. Embodiment One: Identification of Bioactive Compounds in Clove for Treatment of Bacterial Infections (FIG. 2)

### 3.1 Materials and Methods

### Plant Material and Extraction

Clove (Syzygium aromaticum L.) was selected for this embodiment based on its traditional use in treating bacterial infections and its documented antimicrobial properties (Cortés-Rojas et al., 2014). The plant is particularly rich in phenolic compounds, including eugenol, eugenol acetate, and gallic acid, which have demonstrated antimicrobial activity in scientific studies (Fathoni et al., 2017). Dried clove buds were purchased from a reputable herbal supplier in Chengdu, Sichuan Province, China. The botanical identity of the plant material was confirmed through morphological examination and comparison with authenticated reference specimens. The clove material was stored in sealed containers at 4° C. in a light-protected environment to prevent degradation.

The clove material was processed as follows: The dried clove buds were ground into a fine, uniform powder using a mortar and pestle or electric blender. The grinding process increases the surface area available for extraction, thereby improving extraction efficiency. The powder was then air-dried at room temperature or using a freeze-dryer until constant weight was achieved. The dried powder was stored at 4° C. in sealed containers protected from light and moisture.

Extraction was performed using multiple solvents and methods to obtain a comprehensive extraction of bioactive compounds (Ong, 2004). The air-dried powder (20 grams) was extracted with 200 mL volumes of methanol, acetone, and distilled water, separately, at 4° C. A vacuum rotary evaporator was used to evaporate solvent residues from the combined extracts. For hot extraction, a Soxhlet apparatus was employed: 20 grams of powder was placed in the extractor with 200 mL of solvent and extracted for six hours until colorless extracts precipitated in the extractor. After filtration, each extract was concentrated using a rotary evaporator. The resulting sticky mass was dried in a desiccator, and the solid mass was stored in 10% dimethyl sulfoxide (DMSO) with a drop of Tween-20.

Extraction yields were as follows: cold methanol extract, 3.7%; hot methanol extract, 4.2%; cold acetone extract, 3.12%; hot acetone extract, 4.27%; cold water extract, 6.24%; hot water extract, 7.90%; cold aqueous extract, 7.20%; hot aqueous extract, 8.20%. All extracts were maintained at a stock concentration of 30 mg/mL for subsequent use.

Preparation of Clove Capsules: Clove powder was encapsulated in gelatin capsules at a concentration of 350 mg per capsule. A total of 500 capsules were prepared for the clinical study. The capsules were stored at 4° C. in light-protected containers.

### LC-MS Analysis Methodology

Liquid chromatography-mass spectrometry analysis was performed using a Phenomenex C18 column (150×4 mm inner diameter, 5 μm particle size) with a single quadrupole mass spectrometer (Sommer et al., 2006; Keevil, 2013). The mobile phase consisted of 0.5% formic acid in acetonitrile (75:25%) and ammonium acetate in acetonitrile (70:30%), delivered at a flow rate of 0.5 mL/min. The column temperature was maintained at 30° C.

The LC-MS method was validated for analysis of rosmarinic acid (RA) and ursolic acid (UA), which are marker compounds for clove extracts (Mousavi et al., 2018; Sundaram et al., 2012). The assay was linear over the range of 100-1000 ng/ml (R²=0.9997 for RA and 0.9999 for UA). The limit of detection (LOD) was 1 ng/mL for RA and 2 ng/mL for UA. The limit of quantitation (LOQ) was 3 ng/mL for RA and 6 ng/mL for UA. Intraday precision was below 0.14% for RA and 0.11% for UA. Interday precision was below 0.71% for RA and 0.46% for UA. Mean recovery was 94.38% for RA and 92.92% for UA.

### 3.2 Clinical Study Design and Patient Population

### Inclusion Criteria

Patients were eligible for enrollment if they met all of the following criteria: (1) age 18-75 years; (2) clinical diagnosis of bacterial infection confirmed by positive bacterial culture; (3) body temperature of 38.0-39.5° C.; (4) white blood cell (WBC) count greater than 15,000 cells/μL; (5) absence of severe organ dysfunction; and (6) willingness to provide informed consent. 201.

### Exclusion Criteria

Patients were excluded if they met any of the following criteria: (1) known allergy to clove or related plants; (2) concurrent use of antibiotics or other antimicrobial medications; (3) immunocompromised status; (4) pregnancy or lactation; (5) severe organ dysfunction; or (6) inability to provide informed consent.

### Study Protocol

A total of 35 patients who met the inclusion criteria were enrolled in the study. All patients provided written informed consent before enrollment. Patients were treated with clove capsules at a dose of 350 mg twice daily (at 9:00 AM and 9:00 PM) for a duration of 24 hours. 202

Blood samples were obtained before treatment initiation and again 24 hours after the first dose of clove capsules. At each point, patients were also assessed for body temperature, white blood cell count, and bacterial culture status.

### Clinical Outcomes and Patient Classification

Clinical response was defined as meeting all of the following criteria: (1) body temperature reduced to 36.5-37.1° C.; (2) white blood cell count reduced to below 7,500 cells/μL; and (3) negative bacterial culture result. 203

Of the 35 enrolled patients, 22 patients met the criteria for clinical response and were classified as responders (G1). The remaining 13 patients did not meet the response criteria and were classified as non-responders (G2). 203 and 204

### 3.3 Results and Analysis

### Identification of Common Elements

LC-MS analysis of blood samples from the 22 responders (G1) identified over 20 distinct chemical peaks. Systematic analysis of these peaks identified three peaks that were present in all 22 responders. These three peaks were designated as Common Elements C1, C2, and C3 (Table 3). 205

### Analysis of Non-Responder Blood Samples

LC-MS analysis of blood samples from the 13 non-responders (G2) revealed that 7 patients (G3) possessed all three CEs (C1, C2, and C3) despite their failure to respond to clove treatment. The presence of all CEs in these patients suggests that they lack a complete reaction chain, the t biochemical machinery necessary for these compounds to produce a therapeutic effect. 206 and 207

The remaining 6 non-responders (Group 4 or G4) lacked C2, the second Common Element. These patients possessed C1 and C3 but had undetectable or very low concentrations of C2 in their blood (Table 3). 208

### Estimation of C2 Dosage for Treatment

Using pharmacokinetic principles and assuming that C1-C3 has similar kinetic properties in these patients, the concentration of C2 in the original clove capsule was estimated with following formula: assuming average body weight: 70 kg, average moderate distribution, Vd=0.7 L/kg, so total Vd=0.7×70=49 L, average plasma concentration C2 in the responsive patients=10 μg/mL (equivalent to 10 mg/L), the total C2=10 mg/L×49 L=490 mg. 209

Treatment of G4 Patients with Supplemental C2

The 6 patients in G4 (those lacking C2) were treated with supplemental 490 mg C2 at a dose estimated to achieve therapeutic blood concentrations. After treatment, these patients were re-evaluated against the clinical response criteria. 210

Four of the six G4 patients demonstrated clinical improvement after treatment with supplemental C2 and were classified as Group 5 (G5). These results confirm that C2 is a bioactive compound necessary for the therapeutic effect of clove treatment in bacterial infections. 211

The remaining 2 patients did not respond to treatment even after receiving supplemental C2 and were classified as Group 6 (G6). These patients are presumed to lack a complete reaction chain. 212

### 3.4 Conclusions from Embodiment One

This embodiment demonstrates that the methodology of the present invention successfully identifies bioactive compounds in clove that are responsible for its antimicrobial effects. The identification of three Common Elements (C1, C2, C3) in all responders, and the subsequent validation of C2 as a bioactive compound through controlled administration to non-responders, confirms the utility and effectiveness of the present methodology.

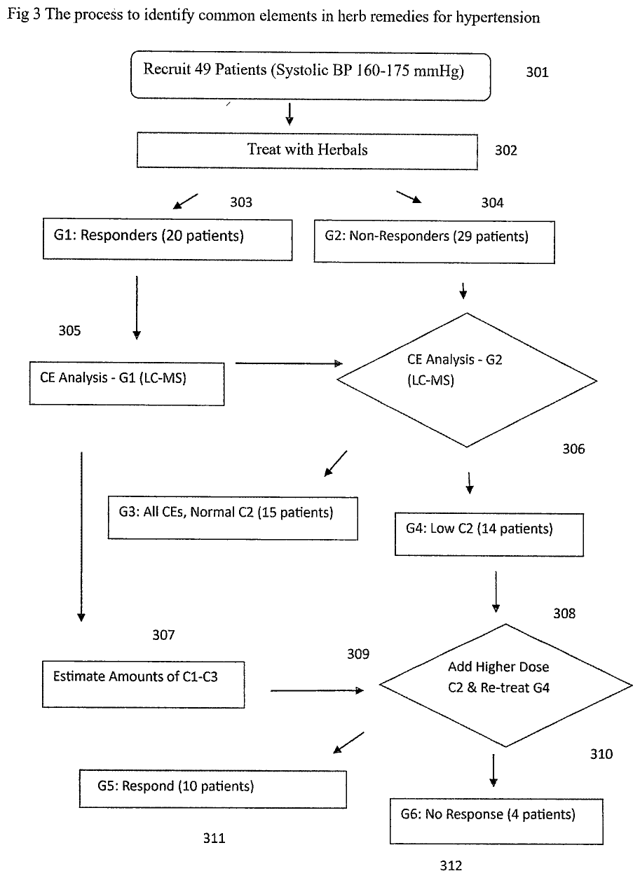

### 4. Embodiment Two: Identification of Bioactive Compounds in Cinnamomum Verum for Treatment of Hypertension (FIG. 3)

### 4.1 Materials and Methods

### Plant Material and Extraction

Cinnamomum verum (Ceylon cinnamon) was selected for this embodiment based on its traditional use in treating hypertension and its documented cardiovascular effects (Singh et al., 2021). Ceylon cinnamon is native to Sri Lanka but is cultivated in numerous regions worldwide. The plant is rich in cinnamaldehyde, cinnamic acid, and other compounds with documented effects on blood pressure and vascular function (Narayanankutty et al., 2021).

Dried cinnamon bark was purchased from a reputable herbal supplier in Chengdu, Sichuan Province, China. The botanical identity was confirmed through morphological examination. The cinnamon material was processed and extracted using the same methodology described for clove in Embodiment One.

### Preparation of Cinnamon Capsules

Cinnamon powder was encapsulated in gelatin capsules at a concentration of 350 mg per capsule. A total of 500 capsules were prepared for the clinical study.

### LC-MS Analysis Methodology

The same LC-MS methodology described in Embodiment One was employed for analysis of cinnamon extracts and patient blood samples.

### 4.2 Clinical Study Design and Patient Population

### Inclusion Criteria

Patients were eligible for enrollment if they met all of the following criteria: (1) age 40-75 years; (2) systolic blood pressure of 160-175 mmHg; (3) diastolic blood pressure of 100-110 mmHg; (4) no current treatment with antihypertensive medications or willingness to discontinue such medications; and (5) willingness to provide informed consent. 301

### Study Protocol

A total of 49 patients who met the inclusion criteria were enrolled. Patients were treated with Cinnamomum verum capsules at a dose of 350 mg twice daily. Blood pressure was assessed before treatment and 2 hours after the first dose. 301 and 302

### Clinical Outcomes and Patient Classification

Clinical response was defined as systolic blood pressure reduced to below 140 mmHg and diastolic blood pressure reduced to below 90 mmHg.

Of the 49 enrolled patients, 20 patients met the response criteria and were classified as responders (G1). The remaining 29 patients were classified as non-responders (G2). 303 and 304

### 4.3 Results and Analysis

### Identification of Common Elements

LC-MS analysis of blood samples from the 20 responders identified three Common Elements (C1, C2, C3) present in all responders. 305

### Analysis of Non-Responder Blood Samples

Of the 29 non-responders, 15 patients (G3) possessed all three CEs but did not respond to treatment, suggesting they might lack a complete reaction chain 306. The remaining 14 patients (G4) had lower concentrations of C2 compared to responders (table 3). 307 and 308

### Estimation of C2 Dosage for Treatment

Using pharmacokinetic principles and assuming that C1-C3 has similar kinetic properties in these patients, the concentration of C2 in the original clove capsule was estimated with following formula: assuming average body weight: 70 kg, average moderate distribution, Vd=0.7 L/kg, so total Vd=0.7×70=49 L, average plasma concentration C2 in the responsive patients=30 μg/mL (equivalent to 30 mg/L), the total C2=30 mg/L×49 L=1470 mg. 309

### Dose-Response Relationship.

The 14 G4 patients were treated with double amounts of C2 (3 g). 309 Ten of these patients (demonstrated clinical improvement (G5) 310, confirming a dose-response relationship for C2. The 4 patients who did not respond (G6) are presumed to lack a complete reaction chain. 311

### 4.4 Conclusions from Embodiment Two

This embodiment demonstrates that the methodology is applicable to different disease conditions and different herbal medicines. The identification of a dose-response relationship for C2 provides additional evidence that this compound is bioactive and that its concentration is a critical determinant of therapeutic efficacy.

### 4.5 Possible Factors Affect Herbal Effectiveness

Table 4 lists a few factors that are involved with human reaction with herbal treatment.

TABLE 1
Identifying Common Elements in Patients' Responses to Clove Treatment of Bacterial Infection

| Compound | P1/2 | P3/6 | P4/9 | P5/11 | P6/10 | P7/8 | P12/15 | P16/18 | P19/20 | P13 | P14/17 |
|---|---|---|---|---|---|---|---|---|---|---|---|
| C1 | xx | | xx | xx | xx | | xx | | xx | xx | xx |
| C2 | | xx | xx | | xx | | xx | xx | xx | xx | |
| C3 | xx | xx | xx | xx | xx | xx | xx | xx | xx | xx | xx |
| C4 | xx | xx | xx | | | xx | xx | | | xx | |
| C5 | xx | xx | xx | xx | xx | xx | xx | xx | xx | xx | xx |
| C6 | xx | | xx | xx | xx | xx | | xx | xx | xx | |
| C7 | | xx | | xx | | | xx | xx | | xx | xx |
| C8 | xx | | xx | xx | xx | | xx | xx | | xx | xx |
| C9 | xx | xx | xx | xx | | xx | xx | | xx | xx | xx |
| C10 | xx | | | xx | xx | | xx | xx | xx | | |
| C11 | xx | | xx | xx | | xx | xx | | xx | xx | xx |
| C12 | xx | | xx | xx | xx | | | xx | xx | xx | |
| C13 | | xx | | xx | | | xx | xx | | xx | xx |
| C14 | xx | | xx | | xx | | | xx | xx | xx | xx |
| C15 | xx | xx | xx | xx | xx | xx | | | xx | xx | xx |
| C16 | xx | | xx | | xx | | xx | xx | xx | xx | xx |
| C17 | xx | xx | xx | xx | | xx | xx | | xx | | xx |
| C18 | xx | xx | xx | xx | xx | xx | xx | xx | xx | xx | xx |
| C19 | xx | | | xx | xx | | xx | xx | | xx | |
| C20 | | xx | xx | xx | | xx | xx | xx | xx | xx | |

Notes:
1. ‘xx’: compound present; blank: compound not present.
2. There are 20 compounds (C1-C20) and 20 patients (P1-P20), grouped into 11 columns for brevity.
3. Only C3 (Eugenol acetate), C5 (methylquinic acid), and C18 (Monogalloylglucose) are present in all patient groups; they are the common elements.
4. Full compound names for all C1-C20 should be provided for enablement (currently partial).

TABLE 2
Identifying Common Elements in Patients' Responses to Herbal Treatment of Hypertension

| Compound | P1/2 | P3/6 | P4/9 | P5/11 | P6/10 | P7/8 | P12/15 | P16/18 | P19/20 | P13 | P14/17 |
|---|---|---|---|---|---|---|---|---|---|---|---|
| C1 | xx | | xx | xx | xx | | xx | | xx | xx | xx |
| C2 | | xx | xx | | xx | | xx | xx | xx | xx | |
| C3 | xx | | xx | xx | xx | xx | xx | xx | | xx | xx |
| C4 | xx | xx | xx | | | xx | xx | | | xx | |
| C5 | xx | xx | xx | xx | xx | xx | xx | xx | xx | xx | xx |
| C6 | xx | | xx | xx | xx | xx | | xx | xx | xx | |
| C7 | | xx | | xx | | | xx | xx | | xx | xx |
| C8 | xx | | xx | xx | xx | | xx | xx | | xx | xx |
| C9 | xx | xx | xx | xx | xx | xx | xx | xx | xx | xx | xx |
| C10 | xx | | | xx | xx | | xx | xx | xx | | |
| C11 | xx | | xx | xx | | xx | xx | | xx | xx | xx |
| C12 | xx | | xx | xx | xx | | xx | | xx | | xx |
| C13 | | xx | xx | | xx | | xx | xx | xx | | |
| C14 | xx | xx | xx | xx | xx | xx | | | xx | xx | xx |
| C15 | xx | xx | xx | | | xx | xx | | | xx | |
| C16 | xx | xx | xx | xx | xx | xx | xx | xx | xx | xx | xx |
| C17 | xx | | xx | xx | xx | xx | | xx | xx | xx | |
| C18 | | xx | | xx | | | xx | xx | | xx | xx |
| C19 | xx | | xx | xx | xx | | xx | xx | | xx | xx |
| C20 | xx | xx | | | xx | xx | xx | xx | xx | xx | xx |

Notes:
1. ‘xx’: compound present; blank: compound not present.
2. There are 20 compounds (C1-C20) and 20 patients (P1-P20), grouped into 11 columns for brevity.
3. Only C5, C9, and C16 are present in all patient groups; they are the common elements.
4. Known compound names: C1 (protocatechuic acid), C2 (Procyanidins A), C3 (coumarin). For enablement, map remaining to LC-MS/MS standards if applicable (e.g., C4: gallic acid? - resolve conflicts).

TABLE 3
Plasma Concentrations of CEs in Responsive and Non-
Responsive Patients with Hypertension

| Compound | Responsive Patients | Non-Responsive Patients |
|---|---|---|
| C1 Protocatechuic acid | 25.2-28.4 ± 2.15 | 23.1-26.5 ± 1.89 |
| C2 A-type procyanidins | 31.1-28.4 ± 3.22 | 3.3-5.8 ± .410 |
| C3 Coumarin | 17.8-19.4 ± 1.46 | 18.6-22.1 ± 2.22 |

Note:
Units are in ng/mL.

TABLE 4
Different Groups Responsive to Herbal Treatment

| | | Reaction Chain | |
|---|---|---|---|
| Group | Synthesis Ability | Complete | Desired Response |
| 1 | Present | Present | Yes |
| 2 | Present | Not complete | No |
| 3 | Not present | Present | Possible |
| 4 | Not present | Not complete | No |

### Discussion on Factors Affecting Herbal Treatment Efficacy (Table 4)

Two primary factors determine the efficacy of an herbal remedy in achieving its intended therapeutic effect. First, the remedy must either inherently contain all requisite bioactive compounds in adequate concentrations or enable the body to synthesize these compounds. Second, a complete biochemical reaction chain must be present to facilitate the proper functioning of the chemical entities (CEs). Based on these factors, herbal responsiveness can be categorized into four distinct groups, as outlined in Table 4.

Group 1: Both synthesis ability and a complete reaction chain are present, resulting in the desired therapeutic response.

Group 2: Synthesis ability is present, ensuring the availability of bioactive compounds; however, an incomplete reaction chain prevents the desired response.

Group 3: Synthesis ability is absent, leading to insufficient bioactive compounds. Nonetheless, a desired response may still be achievable through targeted interventions, such as supplementation in Embodiment One or dose escalation in Embodiment Two.

Group 4: Neither synthesis ability nor a complete reaction chain is present, rendering it impossible to achieve the desired results, even if all bioactive compounds are introduced into the body.

1. A method for identifying bioactive compounds in herbal medicines, comprising:
(a) establishing objective clinical criteria for assessing treatment effectiveness, wherein said criteria are measurable and reproducible;
(b) selecting and preparing herbal medicines based on their traditional use for treating a specific medical condition;
(c) enrolling a population of patients with the target medical condition and administering the herbal medicine according to a defined treatment protocol;
(d) classifying patients as clinical responders who meet the pre-established criteria for clinical improvement, or as non-responders who do not meet said criteria;
(e) obtaining blood samples from both responders and non-responders at a pre-determined time point after herbal medicine administration;
(f) analyzing the blood samples using liquid chromatography-mass spectrometry (LC-MS) or other chemical instruments to identify chemical compounds present in each sample;
(g) identifying Common Elements (CEs) as chemical compounds present in all or substantially all clinical responders;
(h) analyzing blood samples from non-responders to determine which non-responders possess all identified CEs and which lack one or more CEs or with lower CEs;
(i) estimating the concentration of any missing CEs in the original herbal preparation using pharmacokinetic principles;
(j) administering the missing CEs or increased doses of CEs present at lower concentrations than those found in responders to non-responders lacking complete CEs or with lower CEs;
(k) re-evaluating treated patients against the pre-established clinical criteria;
(l) and confirming that the administered CEs are bioactive compounds if treated patients demonstrate clinical improvement meeting the pre-established criteria.

2. The method of claim 1, wherein identifying Common Elements comprises:
(a) analyzing LC-MS data from all clinical responders;
(b) determining each chemical compound across the responder population;
(c) identifying compounds detected in 90-100% of responders as Common Elements.

3. The method of claim 1, wherein administering missing or supplemented CEs comprises:
(a) administering purified, isolated Common Elements obtained from commercial sources;
(b) alternatively, administering synthetically produced Common Elements;
(c) calculating the dose based on the pharmacokinetic estimation performed in claim 1;
(d) administering the CEs using a route of administration appropriate for the specific compounds and medical condition;
(e) re-evaluating patients at a pre-determined time point after CE administration;
(f) confirming that the administered CEs are bioactive compounds if treated patients demonstrate clinical improvement meeting the pre-established criteria.
